(19) United States
(12) Patent Application Publication
(10) Pub. No.: US 2009/0128065 A1
(43) Pub. Date: May 21, 2009

(54) FAN WITH SOFT START FUNCTION

(75) Inventors: Shih-Tzung HSU, Taoyuan Hsien (TW); Chih-Hua LIN, Taoyuan Hsien (TW); Shang-Pei HSIEH, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC, Kuei San (TW)

(21) Appl. No.: 12/210,149

(22) Filed: Sep. 12, 2008

(30) Foreign Application Priority Data
Nov. 16, 2007 (TW) 096143389

(51) Int. Cl. G05B 19/04

(52) U.S. Cl. 318/163

(57) ABSTRACT

A bathroom ventilator fan with the soft-start function includes an impeller and a motor. The motor is coupled to the impeller for driving the impeller to rotate. The motor has a control module for driving and controlling the rotation speed of the motor according to a soft-start signal. The soft-start signal includes a soft-start section and a target-driving section. The control module slowly increases the rotation speed of the motor from the soft-start section to reach the target-driving section.

### CROSS REFERENCE TO RELATED APPLICATIONS

This Non-provisional application claims priority under 35 U.S.C. §119(a) on Patent Application No(s). 096143389, filed in Taiwan, Republic of China on Nov. 16, 2007, the entire contents of which are hereby incorporated by reference.

### BACKGROUND OF THE INVENTION

1. Field of Invention

The present invention relates to a fan and in particular to a bathroom ventilator fan with a soft-start function.

2. Related Art

The bathroom is usually equipped with the bathroom ventilator fan. When the user turns on the switch, the bathroom ventilator fan starts to generate airflows in the bathroom and thus carry the bad smell or moisture out.

However, the conventional bathroom ventilator fan does not have the soft-start function. Thus, once the bathroom ventilator fan is switched on, it will rotate at full speed within a very short time. In this case, the user can obviously hear the noise caused by the bathroom ventilator fan. If the noise raising rate of the bathroom ventilator fan reaches about 10 dB per second, the noise will make the user feel uncomfortable.

In addition, to switch on the bathroom ventilator fan from still state to full speed state requires a very large start-up current. Thus, the inrush current, voltage spike or spike noise may occur in the starting moment when switching on the bathroom ventilator fan. Moreover, the arc (electric arc phenomenon) may be generated to damage the bathroom ventilator fan.

Furthermore, the electric power for driving the conventional bathroom ventilator fan is usually provided by the city electric power system. However, the city electric power system provides the AC power supply, so that the fan powered by the AC power supply usually consumes relatively more energy, which leads to larger power consumption.

### SUMMARY OF THE INVENTION

In view of the foregoing, the present invention is to provide a fan with the soft-start function that can reduce the noise and prevent the inrush current, voltage spike or spike noise, thereby increasing the product reliability, extending the life time of the product and reducing the power consumption.

To achieve the above, the present invention discloses a fan with the soft-start function. The bathroom ventilator fan includes an impeller and a motor. The motor is coupled to the impeller and drives the impeller to rotate. The motor includes a control module for driving and controlling a rotation speed of the motor according to a soft-start signal. The soft-start signal includes a soft-start section and a target-driving section. The control module slowly increases the rotation speed of the motor from the soft-start section to reach the target-driving section.

As mentioned above, the fan of the present invention drives and controls the rotation speed of the motor according to the soft-start signal, so that the rotation speed of the bathroom ventilator fan can be increased slowly to the target rotation speed. Compared with the prior art, the present invention can reduce the noise and prevent the inrush current, voltage spike or spike noise, thereby increasing the product reliability and extending the life time of the product.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a schematic illustration showing a bathroom ventilator fan with the soft-starting function according to an embodiment of the present invention;

FIGS. 2A and 2B are schematic illustrations showing the bathroom ventilator fan powered by the DC power source and the AC power source;

FIG. 3 is a circuit diagram of the bathroom ventilator fan of the present invention; and

FIGS. 4A and 4B are schematic illustrations showing the soft-start signal of the bathroom ventilator fan of the present invention.

### DETAILED DESCRIPTION OF THE INVENTION

The present invention will be apparent from the following detailed description, which proceeds with reference to the accompanying drawings, wherein the same references relate to the same elements.

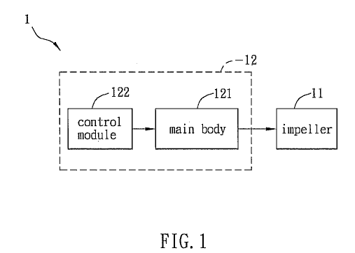

With reference to FIG. 1, a bathroom ventilator fan 1 with the soft-starting function according to an embodiment of the present invention includes an impeller 11 and a motor 12. The motor 12 is coupled to the impeller 11 and drives the impeller 11 to rotate. The motor 12 includes a main body 121 and a controlling module 122 coupled to the motor body 121. The types of the impeller 11 and motor 12 are not limited to the present embodiment. The impeller 11 includes a hub and a plurality of blades (not shown in the figures), and the blades are disposed around the hub. The main body 121 of the motor 12 includes a stator and a rotor, and the motor 12 drives the impeller 11 to rotate. The controlling module 122 can be a micro control unit (MCU).

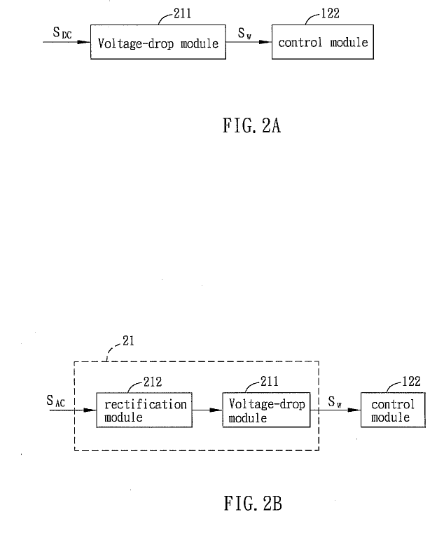

Referring to FIGS. 2A and 2B, a power source, such as a DC power source S_{DC} or an AC power source S_{AC}, is provided to apply power to the motor 12. As shown in FIG. 2A, when the power source is a DC power source S_{DC}, a voltage-drop module 211 is needed to decrease the DC power source S_{DC} to the work voltage S_{W} of the motor 12. As shown in FIG. 2B, when the power source is an AC power source S_{AC}, an AC/DC converter 21 is needed to convert the AC power source S_{AC} into a DC power source. The AC/DC converter 21 includes a voltage-drop module 211 and a rectification module 212 coupled to the voltage-drop module 211. The rectification module 212 can convert the input AC power source S_{AC} to the DC power source S_{DC}. Then, the voltage-drop module 211 decreases the DC power source S_{DC} to the work voltage S_{W} of the motor 12 so as to provide the required electric power for switching on the fan. In the embodiment, the above-mentioned voltage-drop module 211 and rectification module 212 can be the commonly used voltage-drop circuit and rectification circuit, respectively

After the fan is switched on, the control module 122 generates a soft-start signal S_{S} for driving and controlling the rotation speed of the motor. Alternatively, the soft-start signal S_{S} can be generated by an external device such as a soft-start circuit, and then the soft-start signal Ss is transmitted to the control module 122.

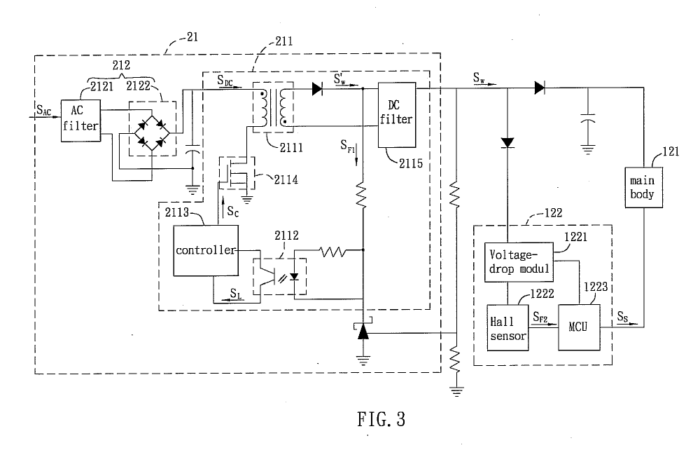

To make the present invention more comprehensive, the implemental circuits of the AC/DC converter 21 and the control module 122 will be described herein below. With reference to FIGS. 2B and 3, the rectification module 212 includes an AC filter 2121 and a bridge rectification circuit 2122. The AC filter 2121 receives the AC power source S_{AC} and filters the low-band frequency portion of the AC power source S_{AC} away. The bridge rectification circuit 2122, which is coupled to the AC filter 2121 and the voltage-drop module 211, converts the AC power source S_{AC} into the DC power source S_{DC}. Then, the DC power source S_{DC} is transmitted to the voltage-drop module 211.

The voltage-drop module 211 includes a transformer 2111, an optical coupler 2112, a controller 2113, a switch 2114 and a DC filter 2115. The transformer 2111 is coupled to the rectification module 212 and decreases the DC power source S_{DC} to the work voltage S′_{W} of the main body 121 of the motor. The optical coupler 2112, which is coupled to the transformer 2111 and the controller 2113, retrieves a feedback signal S_{F1} from the transformer 2111 and outputs a coupling signal S_{L} to the controller 2113. The controller 2113, which is coupled to the optical coupler 2112 and the switch 2114, outputs a control signal S_{C} to the switch 2114 according to the coupling signal S_{L}. The ON/OFF of the switch 2114 can control the transformer 2111 to output stable work voltage S′_{W}. The DC filter 2115 is coupled to the transformer 2111, the main body 121 of the motor and the control module 122 for receiving the work voltage S′_{W}. Then, the DC filter 2115 filters the high-band frequency portion of the work voltage S′_{W} and outputs the work voltage S_{W}, which is the electrical energy for switching on the main body 121 of the motor and the control module 122.

The control module 122 includes a voltage-drop converter 1221, a Hall sensor 1222 and a micro control unit (MCU) 1223. The voltage-drop converter 1221 is coupled to the DC filter 2115, and is for decreasing the work voltage S_{W}. Then, the decreased work voltage S_{W} can be the power source for the Hall sensor 1222 and the MCU 1223. The MCU 1223 is coupled to the main body 121 and generates a soft-start signal S_{S} for driving and controlling the rotation speed of the motor. When the motor is started, the magnetic field will change depending on the rotation speed. The Hall sensor 1222 is coupled to the MCU 1223 and senses the variation of the magnetic field so as to output a feedback signal S_{F2} to the MCU 1223. Then, the MCU 1223 controls the motor body 121 according to the feedback signal S_{F2}. In addition, the implemental circuit of FIG. 3 further shows two diodes for preventing the reverse current.

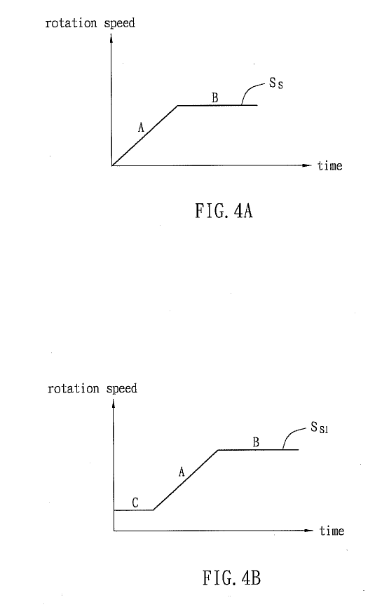

FIG. 4A shows a soft-start signal S_{S} of the present embodiment. The soft-start signal S_{S} includes a soft-start section A and a target-driving section B. The control module 122 slowly increases the rotation speed of the motor 12 from the soft-start section A to reach the target-driving section B. The control module 122 can also adjust a slope of the soft-start section A. Accordingly, the rate (or time) for the motor 12 to reach the target-driving second B can be controlled so as to decrease the noise.

The soft-start section A can be connected to the target-driving section B smoothly. Thus, the rotation speed of the motor 12 can be increased slowly, so that the inrush current, voltage spike or spike noise caused by the rapidly increased rotation speed can be prevented. The soft-start section A can be a linear curve or a second-degree curve. Therefore, when the bathroom ventilator fan 1 is switched on, the rotation speed of the motor 12 can be increased slowly from zero to the target rotation speed (such as a full speed). In the present invention, the noise raising rate of the bathroom ventilator fan 1 during the soft-start section A is not larger than 2 dB per second.

FIG. 4B shows another soft-start signal S_{S1} of the present embodiment. The soft-start signal S_{S1} includes a soft-start section A, a target-driving section B and an initial rotation-speed section C. The control module 122 keeps the rotation speed of the motor 12 at an initial rotation speed according to the rotation speed of the initial rotation-speed section C before the rotation speed of the motor 12 is increased. Then, the control module 122 slowly increases the rotation speed of the motor 12 from the soft-start section A to reach the target-driving section B. In this case, the rotation speed can be increased stably and slowly, so that the noise can also be decreased.

Alternatively, the bathroom ventilator fan with the soft-start function according to the present invention can be a DC fan. An AC/DC converter 21 is configured to convert the AC power source (city electric power) into the DC power source. Then, the DC power source is transmitted to the DC fan for driving the DC fan to rotate. Compared with the AC fan, the DC fan has the advantage of lower power consumption.

Moreover, the bathroom ventilator fan with the soft-start function according to the present invention can be an electrically commutated fan (EC fan), which has an AC/DC converter for converting the AC power source (city electric power) into the DC power source. Then, the DC power source drives the EC fan to rotate. In practice, the additional AC/DC converter is not needed for the EC fan, so the circuit design can be simplified.

In summary, the bathroom ventilator fan of the present invention drives and controls the rotation speed of the motor according to the soft-start signal, so that the rotation speed of the bathroom ventilator fan can be increased slowly to the target rotation speed. Compared with the prior art, the present invention can reduce the noise and prevent the inrush current, voltage spike or spike noise, thereby increasing the product reliability and extending the life time of the fan.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A fan with a soft-start function, comprising:
an impeller; and
a motor coupled to the impeller for driving the impeller to rotate, wherein the motor comprises a control module for driving and controlling a rotation speed of the motor according to a soft-start signal, the soft-start signal comprises a soft-start section and a target-driving section, and the control module slowly increases the rotation speed of the motor from the soft-start section to reach the target-driving section.

2. The fan according to claim 1, wherein the soft-start signal further comprises an initial rotation-speed section, and the control module keeps the rotation speed of the motor at an initial rotation speed according to a rotation speed of the initial rotation-speed section before the rotation speed of the motor is increased.

3. The fan according to claim 1, wherein a power source is provided to apply power to the motor.

4. The fan according to claim 3, wherein the power source is a DC power source or an AC power source.

5. The fan according to claim 4, wherein the AC power source is converted into a DC power source through an AC/DC converter.

6. The fan according to claim 5, wherein the AC/DC converter comprises a rectification module.

7. The fan according to claim 6, wherein the rectification module is a rectification circuit.

8. The fan according to claim 6, wherein the AC/DC converter further comprises a voltage-drop module coupled to the rectification module.

9. The fan according to claim 8, wherein the voltage-drop module is a voltage-drop circuit.

10. The fan according to claim 4, wherein the DC power source is decreased to a work voltage of the motor through a voltage-drop module.

11. The fan according to claim 10, wherein the voltage-drop module is a voltage-drop circuit.

12. The fan according to claim 1, wherein the soft-start signal is generated by the control module.

13. The fan according to claim 12, wherein the control module adjusts a slope of the soft-start section of the soft-start signal.

14. The fan according to claim 1, wherein the control module is a micro control unit (MCU).

15. The fan according to claim 1, wherein the soft-start signal is generated by an external device and then transmitted to the control module.

16. The fan according to claim 15, wherein the external device is a soft-start circuit.

17. The fan according to claim 1, wherein the soft-start section is connected to the target-driving section smoothly.

18. The fan according to claim 1, wherein the soft-start section is a linear curve or a second-degree curve.

19. The fan according to claim 1, wherein a noise raising rate of the fan according to the soft-start section is not larger than 2 dB per second.

20. The fan according to claim 1, which is a DC fan, an AC fan, an electrically commutated fan (EC fan), or a bathroom ventilator fan.
